(19) United States
(12) Patent Application Publication
(10) Pub. No.: US 2002/0157748 A1
(43) Pub. Date: Oct. 31, 2002

(54) Aircraft tire having tread providing self-rotation

(76) Inventor: George Kalman Weller JR., Stanstead (CA)

Correspondence Address: George K. Weller, Jr., Box 473, Derby Line, VT, 05830, US

(21) Appl. No.: 10/121,164

(22) Filed: Apr. 12, 2002

Related U.S. Application Data
(60) Provisional application No. 60/284,056, filed on Apr. 16, 2001.

(51) Int. Cl. B60C 11/00

(52) U.S. Cl. 152/209.5; 152/209.15; 152/209.28

(57) ABSTRACT

The tread surface of a tire for use on an aircraft landing gear includes a plurality of cavities that are formed within the bearing surface. The cavities have a front surface extending from the bearing surface to the bottom of the cavity, the front surface being preferably substantially normal to the tread surface at that location, i.e., radially with respect to the tire, and substantially normal also to the circumference of the tire. The cavities include a second surface that slopes from the bearing surface toward the front surface at the bottom of the cavity. A tire, utilizing such a tread pattern, when positioned such that relative wind is directed toward the front surfaces of the cavities when the tire is at its bottommost position of revolution, experiences self-rotation, achieving a velocity and direction of rotation substantially commensurate with the velocity of the relative wind.

This application claims priority under 35 U.S.C. § 119(e)(1) of provisional application Serial No. 60/284,056, filed Apr. 16, 2001.

### TECHNICAL FIELD OF THE INVENTION

The present invention relates generally to aircraft tires and, more particularly, to an aircraft tire having a tread configured to initiate rotation of the wheel prior to landing.

### BACKGROUND OF THE INVENTION

When an aircraft touches down on a runway at a speed of up to 140 miles per hour, the differential speed between the runway and the landing wheels causes tremendous stress and wear on the tires of the landing wheels such that their average lifespan has been judged to be between two and one hundred landings. Frequent replacement of these tires—ten on a single Boeing 737 airplane alone—impacts significantly on the maintenance time and costs of any commercial or military aircraft fleet.

Throughout virtually the entire history of commercial and military aviation, there have been attempts to alleviate this problem. The solutions have been generally of two different forms: entirely active and at least partially passive. The active solutions involve motors coupled to each landing wheel that spin up the wheels to approximate landing speed just prior to touchdown. These solutions tend to be complex, costly, and add considerable weight to the landing gear. Since these totally active solutions bear no relation to the present invention, they will not be considered further.

There have been a great number of attempted solutions of the more passive type. As examples, the following U.S. patents are intended to be representative of the broad range of solutions of this type.

U.S. Pat. No. 2,403,309, “Tire for Airplane Wheels,” issued Nov. 14, 1942, to Smith, discloses a tire for airplane wheels having a tread formation designed to initiate rotary movement of the tire before landing. The tread or bearing surface of the tire comprises a single raised, solid center rib having a plurality of equally spaced, raised radial ribs extending from the Center rib to the sidewalls. The radial ribs are raised abruptly on the side facing the wind at the bottom of wheel travel, and taper down on their opposite sides.

U.S. Pat. No. 2,417,466, “Manufacture of Pneumatic Tire Treads,” issued Jul. 12, 1944, to Brewer, discloses a process for manufacture of an aircraft tire having raised pockets formed on the tread surface to trap air and thereby initiate wheel rotation during landing.

U.S. Pat. No. 3,773,283, “Self Rotating Airplane Tire,” issued Nov. 20, 1973, to Abplanalp, discloses an aircraft tire provided with circumferential grooves in the tread surface. The grooves include as the floor thereof impeller vanes that present differential resistance to the airstream at vertically opposed locations on the tire to cause the tire to be rotated by the airstream.

U.S. Pat. No. 5,213,285, “Rotating Aircraft Tire/Landing Gear Apparatus,” issued May 25, 1993, to Stanko, discloses an aircraft tire that possesses an array of projections, molded into the tire in at least one channel circling the tire tread on at least one sidewall of the tire, each projection having a forward face for catching air.

U.S. Pat. No. 5,251,848, “Space Shuttle Wheel Acceleration System,” issued Oct. 12, 1993, to Gannatal, discloses a wheel acceleration system including a plurality of attachment bands located in the grooves of a tire and extending around the circumference of the tire. Collapsible cups attached to the attachment bands located at spaced intervals around the tire pop open on the downward portion of a tire revolution to catch the wind and rotate the tire, and collapse on the downwind portion of a revolution to reduce drag.

U.S. Pat. No. 5,417,387, “Aircraft Landing Wheel Rotator,” issued May 23, 1995, to Jennings, discloses an assembly for rotating an aircraft landing wheel by the action of the airstream. The assembly includes a circular plate mounted on the wheel and a plurality of independently movable scoops connected to the outer surface of the plate in circumferentially spaced relation.

U.S. Pat. No. 5,746,393, “Aircraft Wheel Rotating Apparatus,” issued May 5, 1998, to Gennaro, discloses an apparatus for rotating an aircraft wheel comprised of an inner circular portion dimensioned for coupling with the wheel and an outer circular portion integral with an outer end of the inner portion. A plurality of crescent shaped turbine blades are secured to the outer circular portion. The turbine blades are designed so that, when the landing gear is extended during flight, the force of air causes the turbine blades to rotate, directing rotational force to the tires, and the rotating speed to the tires matches the aircraft's ground speed upon touchdown.

U.S. Pat. No. 6,086,017, “Apparatus for Causing an Aircraft Wheel to Rotate,” issued Jul. 11, 2000, to Al-Thani, discloses an aircraft wheel rotating apparatus that includes wind-catching members disposed around a central axis. These members are moved between a non-operative, retracted position and an operative, extended position in which they project outside the radial periphery of the wheel.

It is notable that in spite of the widespread recognition of the need to pre-accelerate the landing wheels of an aircraft, and the plethora of solutions, both patented and unpatented, involving many different approaches addressing this need, no commercial or military aircraft today use any of the known prior art passive apparatuses for landing wheel pre-rotation. Even where patent protection has expired, these many inventions are not considered worthy of use.

The reasons are manifold. The prior art solutions tend to be expensive. They typically add a degree of complexity to the landing gear that reduces its reliability. They may cause unacceptable amounts of vibration to the landing wheels during rotation. And they may reduce the effectiveness of the tread surface during turning maneuvers or on wet runways

Clearly, there exists a need for a simple, cost-effective, foolproof and safe means for accelerating the landing wheels rapidly to a rotational speed corresponding to the forward velocity of the aircraft so as to minimize the amount of wear on the tires upon impact, and which overcomes the defects and deficiencies of prior art apparatuses and systems.

### SUMMARY OF THE INVENTION

In view of the foregoing disadvantages inherent in the known types of aircraft wheel rotation devices and methods now present in the prior art, the present invention provides an improved means for producing aircraft wheel rotation. As such, the general purpose of the present invention, which will be described subsequently in greater detail, is to provide a new and improved aircraft wheel rotating apparatus that has all of the advantages of the prior art and none of the disadvantages.

It is therefore an object of the present invention to provide an aircraft tire having a tread pattern that will catch the air and induce rotation of the wheel prior to landing.

It is another object of the present invention to provide such an aircraft tire that is inexpensive to produce.

It is another object of the present invention to provide such an aircraft tire that is simple and requires no external influence or attachment to induce such rotation.

It is another object of the present invention to provide such an aircraft tire that minimizes vibration caused by the rotation of the wheel.

It is another object of the present invention to provide such an aircraft tire that maintains or improves the effectiveness of its tread surface during turning maneuvers or on a wet runway.

In accordance with the principles of the present invention, there is disclosed herein an aircraft wheel assembly including a tire having a tread pattern comprising cavities. The cavities are shaped to induce rotational motion to the tire corresponding to the direction of motion of the wheel assembly.

Further in accordance with the present invention, there is disclosed herein an aircraft tire having a tread surface with a plurality of cavities formed therein, each cavity having a first surface substantially normal to the tread surface and substantially normal to the circumference of the tire, each cavity increasing gradually in depth from the tread surface to the first surface at the bottom of the cavity. In accordance with one embodiment of this invention, the tread surface includes a circumferential channel. In various embodiments, gaps are provided which couple two cavities, or a cavity and the channel, or a cavity and a side surface of the tire. In embodiments of the invention, the cavities are distributed laterally and circumferentially across the tread surface, and are staggered with respect to one another in the lateral direction of the tread surface, and may be distributed on outer edges of the tread surface with at least one central groove. According to the present invention, the first surface may be planar, concave or convex. According to one embodiment of the present invention, a second surface of the cavity extends from the tread surface gradually downward to the first surface at the deepest portion of the cavity. According to another embodiment of the present invention, a second surface of the cavity extends from the tread surface gradually downward to the deepest portion of the cavity, and a third surface, substantially parallel to the tread surface, extends between the second surface at the bottom of the cavity and the first surface at the deepest portion of the cavity.

An aircraft, employing the tire in accordance with the present invention, has the tire positioned such that when each cavity is at its lowermost position of rotation, its first surface is impinged by the relative wind, thereby imparting forward rotation of the tire.

### BRIEF DESCRIPTION OF THE DRAWINGS

The foregoing features of the present invention may be more fully understood from the following detailed description, read in conjunction with the accompanying drawings, wherein:

FIG. 1 is a plan view of a portion of the tread surface of a tire for use on an aircraft landing gear in accordance with the present invention;

FIG. 2a is a sectional view of a portion of the tread pattern of the tire of FIG. 1 in accordance with one embodiment of the cavity configuration;

FIG. 2b is a sectional view of a portion of the tread pattern of the tire of FIG. 1 in accordance with another embodiment of the cavity configuration;

FIGS. 3a, 3b and 3c are plan views illustrating cavities in the tread pattern of FIG. 1 in accordance with three embodiments of the present invention; and

FIG. 4 illustrates the rotational effect of the relative wind on the tire of FIG. 1.

### DESCRIPTION OF THE PREFERRED EMBODIMENTS

Referring initially to FIG. 1, there is shown in plan view of a portion of the tread surface 10 of a tire for use on an aircraft landing gear in accordance with the present invention. At the outset, it should be noted that the drawings are shown only for purposes of understanding of the invention, and that the relative dimensional aspects of their elements may not be accurately reflected therein. Tread surface 10 includes a bearing surface 12 that provides contact with a runway. A typical aircraft tire includes one or more circumferential channels 14 (two are shown) which provide an egress for expulsion of water when being driven on a wet runway, and which also enhance traction between the tire and runway during turning maneuvers. Channels 14 are typically positioned centrally on tread surface 10.

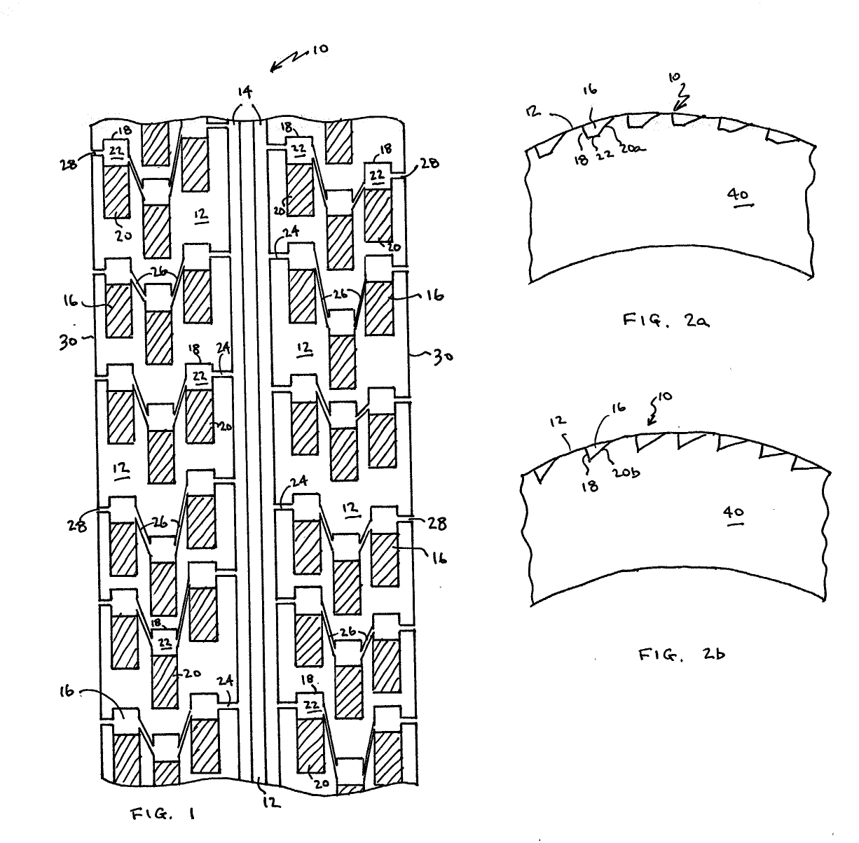

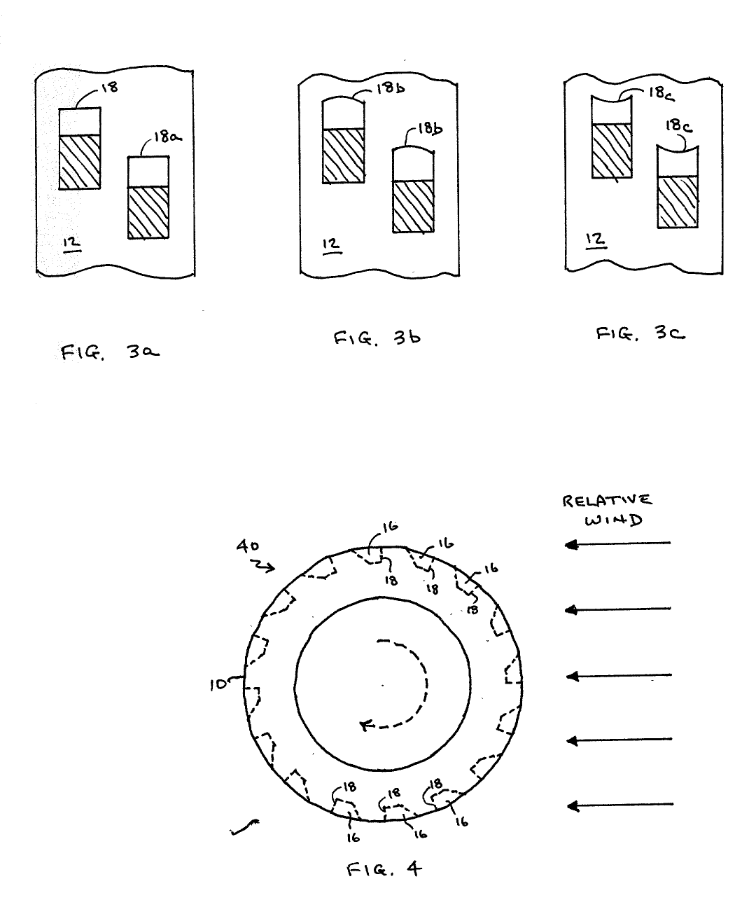

In accordance with the present invention, a plurality of cavities 16 are formed within bearing surface 12. While cavities 16 may assume any of several shapes (as will be discussed later in regard to FIGS. 2a, 2b, 3a, 3b and 3c), there are certain minimum configurational requirements needed to provide the wind-induced wheel rotation in accordance with the stated objects of the present invention.

Cavities 16 have a first wall (or surface) 18 extending from bearing surface 12 to the bottom of cavity 16. Surface 18 is preferably substantially normal to tread surface 10 at that location, i.e., radially with respect to the tire. As shown in FIG. 1, surface 18 is also normal to the circumference of the tire, but this is not deemed to be a necessary limitation, as it may be determined that performance may be enhanced by skewing surface 18 one way or the other with respect to the circumference of the tire.

Cavities 16 include a second surface 20, which slopes from bearing surface 12 toward surface 18 at the bottom of cavity 16. In general, it may be said that the more gradual and uniform the slope of surface 20, the more effective is the present invention in accomplishing its stated purposes. In the embodiment of FIG. 1, sloped surface 20 meets surface 22 at the bottom of cavity 16. Surface 22, the “floor” of cavity 16, extends between surfaces 18 and 20.

Practical considerations require that cavities be able to expel runway water to minimize the effect of hydroplaning, which results when runway water cannot be expelled quickly enough from beneath the tire, causing the tire to ride on a thin surface of water, thereby losing contact with the runway. Lacking an adequate means of egress, standing water on a runway may be trapped within cavities 16, resulting in a diminishment of traction. As such, the embodiment of FIG. 1 includes a series of gaps in bearing surface 12. Gaps 24 provide paths for water to traverse between a cavity 16 and a circumferential channel 14. Gaps 26 provide paths for water to traverse between two cavities 16. And gaps 28 provide paths for water to traverse between a cavity 16 and an open sidewall 30 of tread surface 10.

Referring now to FIG. 2a, there is shown a sectional view of a portion of the tread pattern of tire 40 in accordance with one embodiment of the cavity configuration. This embodiment is similar to that shown in FIG. 1. Cavity 16 comprises a front surface 18, substantially normal to bearing surface 12; a floor surface 22, substantially parallel to bearing surface; and a sloping surface 20a, sloping gradually down from bearing surface 12 to floor surface 22.

FIG. 2b illustrates a sectional view of a portion of the tread pattern of tire 40 in accordance with another embodiment of the cavity configuration. In this embodiment, there is no floor surface, and sloping surface 20b extends gradually down from bearing surface 12 to the bottommost portion of front surface 18.

Referring now to FIGS. 3a, 3b and 3c, there are shown plan views illustrating cavities 16 in the tread pattern in accordance with three embodiments of the present invention. The difference between these embodiments inheres in the shape of the front surfaces 18 of cavity 16. The present invention is intended to encompass several shapes of front surface 18, including planar surface 18a (FIG. 3a), concave surface 18b (FIG. 3b), convex surface 18c (FIG. 3c), as well as irregular shapes which adequately serve the function of providing a surface for the impingement of moving air.

FIG. 4 illustrates the self-rotational effect of the relative wind on tire 40 including the tread surface 10 as shown in and as described in relation to FIG. 1. Tire 40, traveling in a direction from left to right on the page, encounters relative wind (as shown by the straight arrows) which is the vector sum of the ground speed of the aircraft and the wind speed relative to the ground. Wind directed toward tread surface 10 at the bottom of tire 40, impinges on the substantially normal front surfaces 18 on cavities 16, causing localized high pressure regions and thereby tending to rotate tire 40 in a clockwise direction, i.e., commensurate with the direction of travel of the aircraft. Wind directed toward tread surface 10 at the top of tire 40, impinges on a sloping or beveled surface, and is deflected therefrom with a minimum of force against tread surface 10. The net result is a rapidly accelerating self-rotation of tire 40 until it reaches a velocity corresponding closely to that of the relative wind.

In the present invention, it is significant that the air impingement surfaces 18 are located at the circumference of tire 40, unlike in many prior art devices. In this way, the maximum torque (force times moment arm) is imparted to tire 40. As an aircraft approaches a landing, it lowers its landing gear at a speed greater than the touchdown speed, e.g., 200 miles per hour for a 140 miles per hour touchdown speed. This higher speed provides added torque to the tires, overcoming bearing friction and spinning the tires to very close to actual landing speed. The higher speed also permits the use of smaller impingement surfaces, thereby maximizing the amount of tire bearing surface available for contact with the runway.

It should be noted that, in the depiction of FIG. 1, cavities 16 are positioned on tread surface 10 in an irregular configuration in the circumferential direction, and are also staggered with respect to one another across the width of tread surface 10. By avoiding any regularity in their placement, harmonic resonances which may give rise to unwanted vibrations are avoided. It is expected that resonance studies may be needed to establish an optimal positioning scheme of cavities 16 on tread surface 10 to effectively minimize harmful vibrations.

While the principles of the present invention have been demonstrated with particular regard to the structures disclosed herein, it will be recognized that various departures may be undertaken in the practice of the invention. The scope of the invention is therefore not intended to be limited to the particular structures disclosed herein, but should instead be gauged by the breadth of the claims that follow.

What is claimed is:

1. An aircraft tire having a tread pattern comprising cavities shaped to induce rotational motion to the tire corresponding to the direction of motion of the wheel assembly.

2. An aircraft tire having a tread surface with a plurality of cavities formed therein, each cavity having a first surface substantially normal to the tread surface and substantially normal to the circumference of the tire, each cavity increasing in depth from the tread surface to the first surface.

3. The aircraft tire in accordance with claim 2 wherein the tread surface includes a circumferential channel.

4. The aircraft tire in accordance with claim 3 wherein the tread surface includes at least one gap coupling at least one cavity to the channel.

5. The aircraft tire in accordance with claim 2 wherein the tread surface includes at least one gap coupling at least one cavity to a side surface of the tire.

6. The aircraft tire in accordance with claim 2 wherein the tread surface includes at least one gap coupling two cavities.

7. The aircraft tire in accordance with claim 2 wherein the cavities are distributed laterally and circumferentially across the tread surface.

8. The aircraft tire in accordance with claim 2 wherein the cavities are staggered with respect to one another in the lateral direction across the tread surface.

9. The aircraft tire in accordance with claim 2 wherein the cavities are unequally spaced with respect to one another in the circumferential direction along the tread surface.

10. The aircraft tire in accordance with claim 2 wherein the first surface is substantially planar.

11. The aircraft tire in accordance with claim 2 wherein the first surface is substantially concave.

12. The aircraft tire in accordance with claim 2 wherein the first surface is substantially convex.

13. The aircraft tire in accordance with claim 2 wherein the cavities are distributed near the outer edges of the tread surface, the tread surface including at least one circumferential channel in the center region of the tread surface.

14. The aircraft tire in accordance with claim 2 wherein at least one cavity includes a second surface extending from the tread surface gradually downward to the first surface at the deepest portion of the cavity.

15. The aircraft tire in accordance with claim 2 wherein at least one cavity includes a second surface extending from the tread surface gradually downward to the deepest portion of the cavity, and further includes a third surface substantially parallel to the tread surface, the third surface extending between the second surface at the bottom of the cavity and the first surface at the deepest portion of the cavity.

16. An aircraft having the aircraft tire in accordance with claim 2, wherein the tire is positioned such that when each cavity is at its lowermost position of rotation, its first surface is impinged by the relative wind, thereby imparting forward rotation of the tire.
